(19) United States
(12) Patent Application Publication
(10) Pub. No.: US 2014/0149214 A1
(43) Pub. Date: May 29, 2014

(54) PROOF POINTS OF PRODUCT PRICE REDUCTIONS

(71) Applicant: WAL-MART STORES, INC., Bentonville, OR (US)

(72) Inventors: Stuart Argue, Palo Alto, CA (US); Emile Marcar, San Francisco, CA (US)

(73) Assignee: Wal-Mart Stores, Inc., Bentonville, AR (US)

(21) Appl. No.: 13/688,096

(22) Filed: Nov. 28, 2012

(51) Int. Cl. G06Q 30/02

(52) U.S. Cl. CPC G06Q 30/0255
USPC 705/14.53

(57) ABSTRACT

A system and method for notifying a retail customer with respect to recent price reductions for products of interest to the customer. The system and method include identification of such products of interest by gathering and analyzing past purchase behavior, demographic data, and the like. By analyzing such data to identify products of relatively high importance to the customer and presenting notifications of price reductions of such identified products, the retailer may successfully instill in the customer the impression that the retailer offers lower prices than its competitors. Such impressions may be likely to increase customer loyalty and encourage repeated return shopping trips.

### BACKGROUND INFORMATION

1. Field of the Disclosure

The present disclosure relates generally to notifying a customer about prices of products. More particularly, the disclosure relates to informing customers about reduced prices for products of interest.

2. Background

One objective that may be important to retail establishments is building customer loyalty. A typical way that retailers may attempt to build loyalty with customers and prospective customers is by advertising that the retailer has low prices. Retailers may accomplish this by conveying the impression that the retailer has low prices relative to other retailers.

Product price reductions by a retailer may create lasting positive impressions on the retailer's customers. Price reductions on products that a customer purchases on a regular basis, or that are otherwise relevant to the customer's shopping needs, may create an even stronger positive impact on the customer. Even still, a typical customer may not remember the recent purchase price of such products; thus a price reduction by a retailer may escape the customer's attention and the opportunity for the retailer to strengthen that customer's loyalty could potentially be lost.

What is needed, therefore, is a system for notifying the customer of any price reductions for products of interest to the customer.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 is a block diagram depicting an embodiment a price reduction notification system of the present disclosure;

FIG. 2 is a process flow chart depicting a price reduction notification method of the present disclosure;

FIG. 3 is an illustration of a smartphone showing a price reduction notification according to an embodiment of the present disclosure; and.

FIG. 4 is an illustration of a smartphone showing a price reduction notification according to a second embodiment of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the spirit and scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

The flowchart and block diagrams in the attached figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

One objective of the systems and methods disclosed herein is to call a customer's attention to price reductions of products that are of particular interest to the customer. To accomplish this objective, systems and methods of the present disclosure may provide a server, computer, and/or database network adapted to: track purchase habits of a customer; identify products that the customer purchases on a repeated basis, products that the customer is likely to purchase in the future based on the customer's purchasing habits, complementary products, or other products in which the customer may have some level of interest; and notify the customer of any price reductions, if any, for such products. Such notifications may be presented to the customer on a mobile computing device, such as a smartphone, via application software installed thereon and in conjunction with presentment of an electronic receipt reflecting a retail transaction.

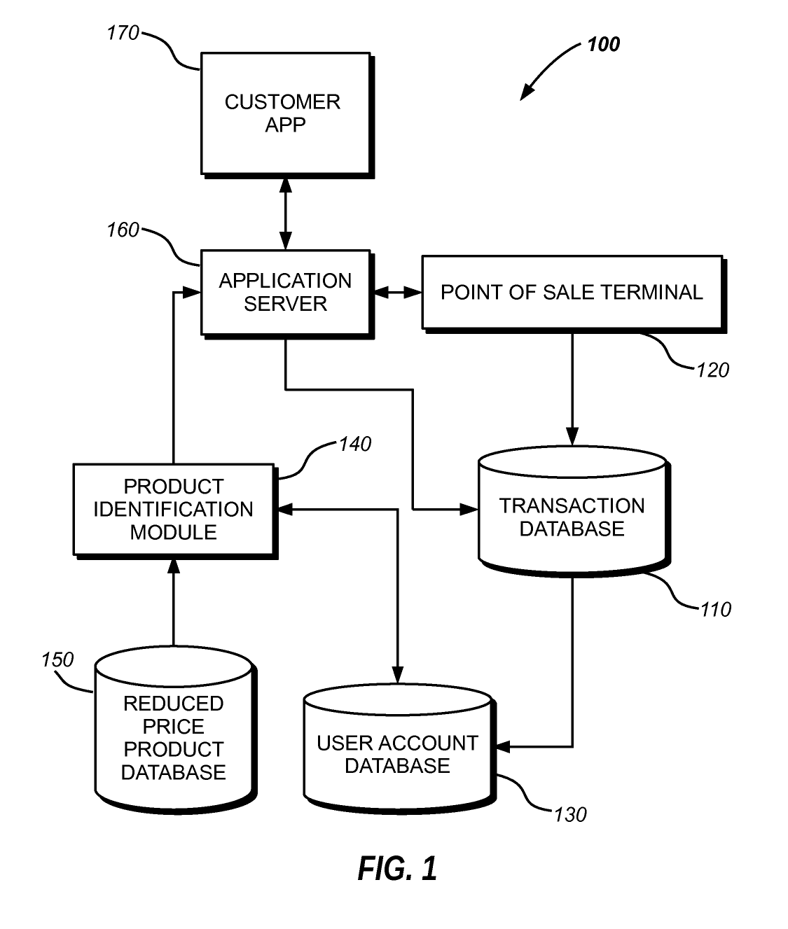

With reference to FIG. 1, price reduction notification system 100 of the present disclosure comprises a transaction database 110 for maintaining a record of purchases made by retail customers. The transaction database 110 may associate certain retail purchase transactions with a customer. In particular, a transaction is linked within transaction database 110 to a unique customer identification number (“CIN”). Such transactions may be linked to customers at the time of sale by the customer or a retail sales associate inputting identifying indicia of the customer into a point of sale (“POS”) terminal 120. Identifying indicia that may be entered into the POS terminal 120 at the time of transaction may include the CIN, the customer's name, the customer's telephone number, the customer's credit or debit card number, or the like. In alternative embodiments, customers carry a keychain tag or card that comprises identifying indicia thereon, such as a barcode of the CIN, an RFID tag carrying the CIN, or the like. The tag or card may be input at the POS terminal 120 by a reader.

Upon input of a customer's CIN or other identifying indicia during a transaction, data related to that transaction is entered into the transaction database 110. Said data may include the product(s) purchased, including product UPC numbers or other product codes, the price paid for each product, the CIN, the date and time, and other relevant information about the transaction. Such data is aggregated and stored in transaction database 110 for later retrieval as described below. In alternative embodiments, transaction database 110 additionally stores historical pricing data for particular stores. In alternative embodiments, transactions may be input to transaction database 110 at any time after completion of the transaction by inputting a code on a receipt for that transaction. The code could be represented by a hyperlink, a unique numerical code, a one- or two-dimensional barcode on the receipt, or other means. In embodiments, the code for that transaction may be input by a customer scanning the receipt, or particularly the barcode thereon, with a smartphone. In alternate embodiments, the code on the receipt is submitted on a webpage by a customer. Upon inputting the code, application server 160 transmits the customer's identifying indicia with a transaction identifier to the transaction database 110, which associates the transaction with that customer.

The price reduction notification system 100 of the present disclosure further comprises user account database 130, which aggregates data related to a customer. User account database 130 comprises a customer's purchase history, demographic information about the customer, and any other information gathered by the retailer that may be relevant to the customer's purchasing habits. In embodiments, the transaction database 110 is periodically queried for additional transactional data that is linked with a particular customer for inclusion into user account database 130 in connection with said customer. Alternatively, upon completion of a transaction, transaction database 110 transmits data regarding the transaction to user account database 130.

Price reduction notification system 100 further comprises product identification module 140. Product identification module 140 may be embodied on a server having computer-readable instructions and programming to analyze the data in user account database 130 pertaining to a customer and to identify particular products that may be of interest to said customer. As used herein, the term “products of interest,” as it relates to a customer, means products that the customer is likely to purchase in the future. Products of interest may include products that the customer recently purchased. Generally, products of interest are products that may hold some particular importance to a customer, such that if the customer receives notification that said products were price-discounted, a positive sentiment toward the retailer may be instilled in the customer as a result of the price reduction notification.

For example, product identification module 140 may identify products of interest to a customer by analyzing the customer's recent shopping behavior and identifying products that the customer has recently purchased and/or has purchased multiple times in prior shopping trips. Alternatively, product identification module 140 may identify products that are similar or complementary to recently-purchased products. Alternatively, product identification module 140 may analyze a wide variety of customer data, such as customer demographic data, seasonal shopping behaviors, and the like to identify products of interest to the customer. Other known methods for identifying products of interest also fall under the scope of this disclosure.

Product identification module 140 queries reduced price product database 150 for products that have been found to be of interest to a customer and that have had a price reduction. In embodiments, product identification module 140 queries reduced price product database 150 for any past price reductions. In alternate embodiments, product identification module 140 queries reduced price product database 150 for recent price reductions. As used herein, the term “recent” may mean any time since a preselected time threshold, for example any time in the prior seven days. Alternatively, the term “recent” may mean any time since a customer's previous shopping trip (e.g., the customer's most recent shopping trip). The length of time used as a threshold may be dependent upon the type of product under consideration. For example, a type of product that is typically purchased with relative low frequency may be analyzed under a longer time threshold than a common item that has a relatively higher typical purchasing frequency.

Product codes and data for identified products of interest that have recently-reduced prices are transmitted to application server 160. Application server 160 is adapted to interface with POS terminal 120 and customer app 170. In embodiments, customer app 170 is an application installed on a smartphone or similar mobile device. In alternative embodiments, customer app 170 is a web application (i.e. a web browser-supported software application).

Application server 160 provides notice to customer of products identified by product identification module 140. In embodiments, application server 160 provides such price alerts to customer by presenting information in conjunction with presentment of an electronic receipt that is displayed via the customer app 170 upon completion of a transaction. In alternate embodiments, price alerts are provided to customer at times other than transaction time. For example, the customer may receive a price alert as described herein upon entering the retail store, at selected times of day, or upon identification of a price reduction by product identification module. Product identification module 140 may accomplish its identification function asynchronously (as product price reduction occurs) or may run its analysis upon specific triggering occurrences. For example, product identification module 140 may identify products when a customer enters a retail store, or upon initiation or completion of a retail transaction.

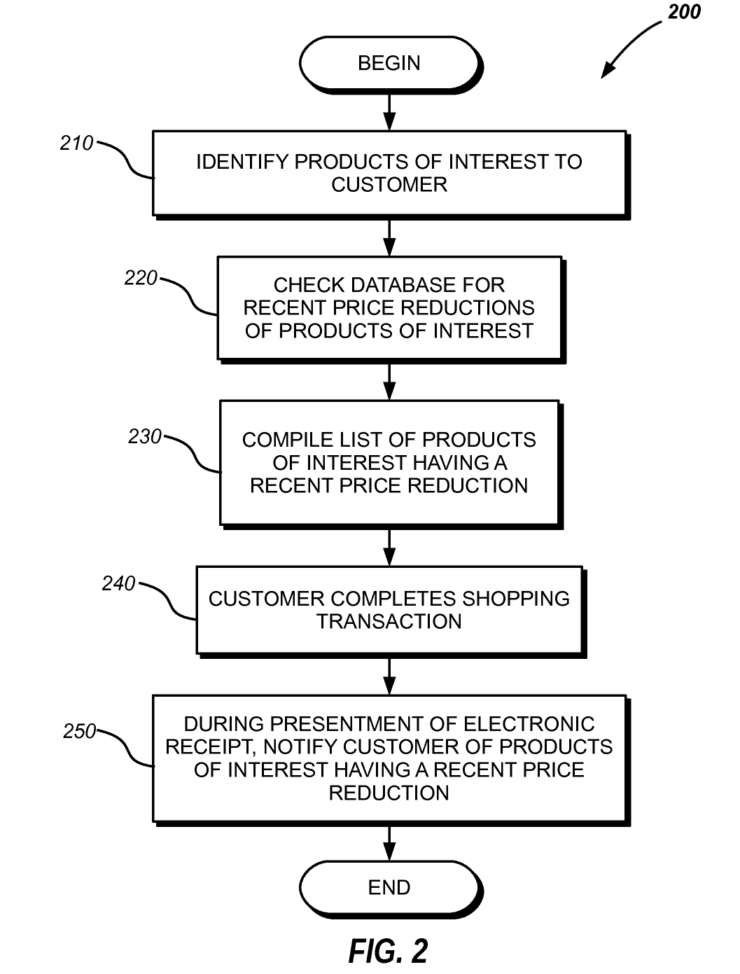

Referring now to FIG. 2, a method 200 is disclosed whereby a customer is notified of price reductions for products of interest. Method 200 comprises operation 210, during which product identification module 140 identifies products of interest to customer. As described above, the product identification module 140 may accomplish this operation by analyzing past purchasing behavior, demographic data, or other factors such as the current season, popular trends, and the like. Method 200 further comprises operation 220, wherein the product identification module 140 queries the reduced price product database 150 for past price reductions of the identified products of interest. Method 200 further comprises operation 230, which comprises compiling a list of products of interest that have received a price reduction. Method 200 further comprises operation 240, in which the customer completes a shopping transaction with the retailer. Method 200 further comprises operation 250, wherein the customer is notified of the reduced prices in identified products of interest via notification contained in an electronic receipt. In alternative embodiments, the customer is notified of reduced prices for products of interest while the customer is shopping.

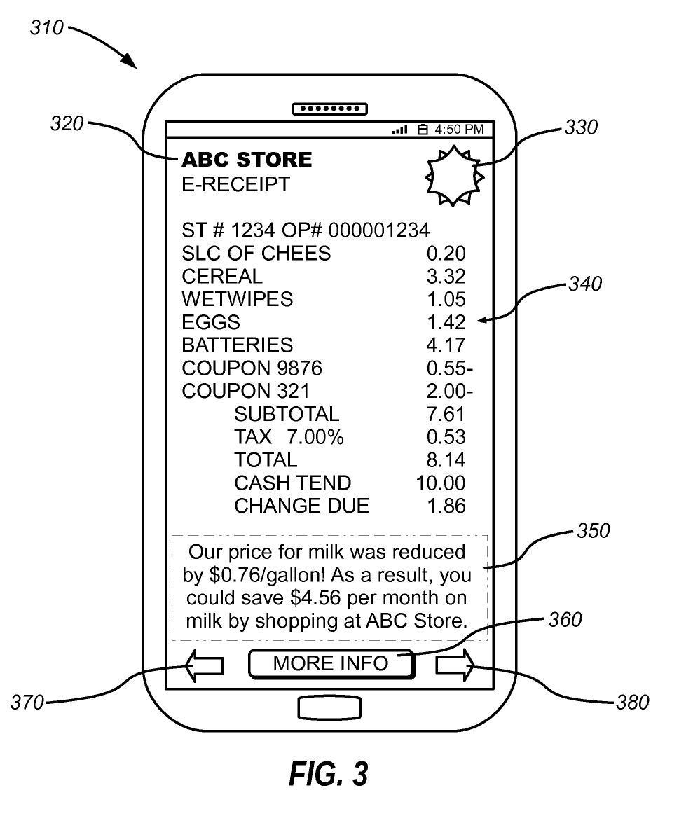

Referring now to FIG. 3, an embodiment of the present disclosure is depicted, showing a possible appearance of an electronic receipt on a smartphone 310 or like device. An electronic receipt may comprise a store name 320 and logo 330 as is commonly included on traditional paper receipts. The electronic receipt may further comprise transaction information 340, similar to a traditional paper receipt. Price-reduction notification 350 appears on the electronic receipt on-screen in a conspicuous location so as to alert the customer of the reduction. Price-reduction notification 350 may be provided regarding any products of interest that have recent price reductions, whether or not the customer has purchased such products.

As depicted in FIG. 3, notification 350 may indicate a specific dollar amount of savings for the product. In alternative embodiments, notification 350 selectively indicates a percentage savings rather than an absolute dollar amount. Application server 160 is adapted to determine whether a notification indicating an absolute dollar amount or a notification indicating a percentage is more impactful to the customer. Such a determination may be made based on an understanding of human psychology and a consideration of how a typical customer may be affected by the notification 350. For example, a notification that a product is less expensive by $0.54 may carry more impact for a customer than a notification that the same product is 2% less expensive, as 2% may be understood by customers to be a low price reduction amount. On the other hand, a notification that a product is 45% cheaper may carry more impact than a notification that the same product is $2.05 less expensive, as 45% may be interpreted as a relatively high price reduction value. In alternative embodiments, an impact threshold is selectively put in place to restrict presentment of price reduction notifications to only those deemed to provide a sufficient level of impact to the customer. Thus, the system may, at times, present no notifications of price reductions because no price reductions were significant enough to be shown to the customer. Price reduction notifications 350 may be rotated for any customer so that customers do not receive multiple subsequent repeat notifications 350. Product identification module 140 can transmit, to user account database 130, data regarding which price notification message 350 was displayed in order to track past messages of price notification 350 and to de-prioritize recently displayed notifications 350.

In embodiments, button 360 is displayed to allow the customer to request additional information related to the displayed price notification. Upon selection of the button 360, an information screen is displayed that provides additional content related to the relevant products. Additional content may include a showing with respect to how the customer may save the specific monthly amount (e.g., “You typically purchase six gallons of milk per month. At a savings of $0.76 per gallon, you will save $4.56 per month on milk by shopping at ABC Store.”). Alternatively, application server 160 can be adapted to provide additional marketing material on-screen, which marketing material is related to the product being described or other products that were identified as products of interest to the customer. In embodiments of the present disclosure, the information screen comprises a call to action. The call to action may comprise a link for the customer to click for more information or the like. The call to action may be used to test the effectiveness of the information screen and/or the notification 350 by tracking click-through rates from button 360 or other call to actions.

In alternative embodiments, such notifications are displayed on-screen for multiple products having reduced prices. Referring back to FIG. 3, the customer may be provided with the option to select additional notifications by pressing left arrow 370 or right arrow 380 to review any number of provided notifications in sequence. In embodiments, the price reduction notification system 100 may identify numerous products of interest but selectively display only the notifications deemed to create the strongest impact on the customer. A determination of strongest impact may be based on the following factors that are provided as examples: how often that product of interest was purchased by the customer, how often the customer purchases products that are complementary to that product of interest, how much the customer will save per purchase, and how much the projected savings is for the customer.

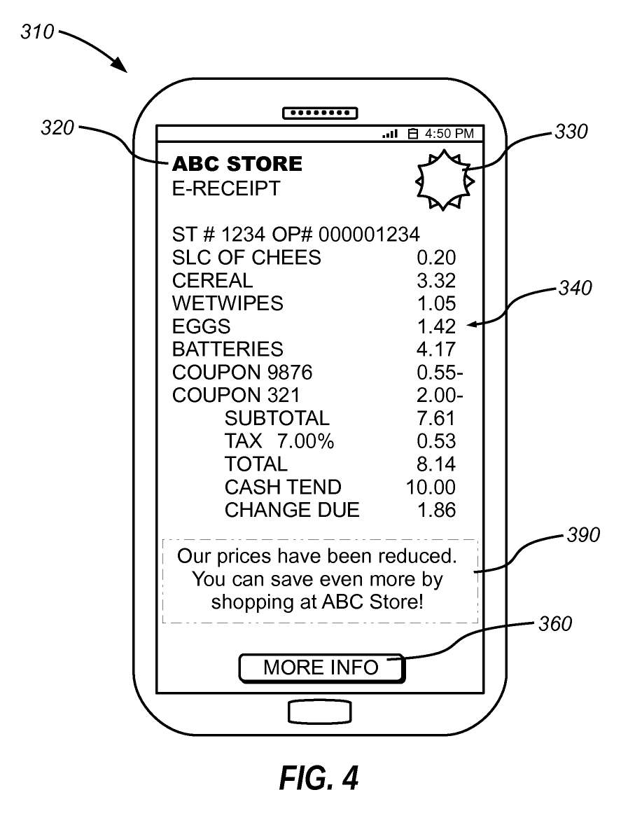

Referring now to FIG. 4, embodiments of the present disclosure comprise notification 390 or like message that may not provide specific details regarding which products have been price-reduced, how much the price reduction was, and/or what the monthly savings may be. In the embodiment depicted, button 360 is displayed, which gives the customer the option to see an information screen related to that notification 390. Such an information screen may contain the price reduction amount, the customer's potential monthly savings, and/or additional information related to the product. By tailoring the notification 390 for the specific customer, the retailer may maximize optimize click-through rates and therefore the effectiveness of notification 390.

In alternative embodiments, the customer receives a push notification on the customer's mobile computing device that indicates that an electronic receipt has been prepared and may be viewed on the mobile device. Such a push notification may be transmitted to the mobile device following a retail transaction. The push notification may provide the customer the option to view the electronic receipt. The push notification may further provide a basic level of information regarding a price reduction on a product of interest and the customer's projected savings. Further, the push notification may give the customer the option to view additional details regarding the price reduction. In embodiments, the system may provide split testing with different push notification messages to determine which push notification messages are most effective. An algorithm may be used to select the most effective notification message 350 as determined by click-through rates or other factors.

Alternative embodiments of the present disclosure comprise notification messages 350 or 390 having projections for any timeframe that is suited to the customer or the product being sold. For example, message 350 or 390 may inform that customer what the savings are projected to be over the course of six months rather than a single month. Determinations of which timeframe may be more impactful to a customer may be made by one of ordinary skill in the art having the benefit of this disclosure. Alternatively, split testing as described above may be used to find optimal time frames under which to present potential savings amounts to customers.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the spirit and scope of the present disclosure.

What is claimed is:

1. A computer-implemented method of notifying a customer regarding a product price reduction comprising:
receiving, at a database, records of shopping purchases by the customer;
identifying, at a product identification module, at least one product of interest to the customer by analyzing the records of shopping purchases;
determining, at the product identification module, if any of the at least one product of interest have received a price reduction; and
notifying the customer if any of the at least one product of interest have received a price reduction.

2. The method of claim 1, wherein notifying the customer if any of the at least one product of interest have received a price reduction comprises presenting a notification on a display of a mobile computing device.

3. The method of claim 2, further comprising presenting an electronic receipt on the display simultaneously with presenting the notification.

4. The method of claim 3, wherein presenting an electronic receipt on the display simultaneously with presenting the notification occurs upon completion of a retail transaction.

5. The method of claim 1, wherein notifying the customer if any of the at least one product of interest have received a price reduction occurs while the customer is within a retail store.

6. The method of claim 1, further comprising estimating a projected cost savings for the customer for the at least one product of interest.

7. The method of claim 6, wherein the projected cost savings is estimated over a time period of one month.

8. The method of claim 6, wherein the projected cost savings is estimated over a time period of twelve months.

9. The method of claim 1, further comprising providing a push notification message indicating that an electronic receipt is available for the customer to view.

10. The method of claim 1, wherein notifying the customer if any of the at least one product of interest have received a price reduction comprises communicating a percentage price reduction to the customer.

11. The method of claim 1, wherein notifying the customer if any of the at least one product of interest have received a price reduction comprises communicating a dollar amount price reduction to the customer.

12. The method of claim 1, wherein determining if any of the at least one product of interest have received a price reduction comprises determining if any of the at least one product of interest have received a price reduction in a preceding two week period.

13. The method of claim 1, wherein determining if any of the at least one product of interest have received a price reduction comprises determining if any of the at least one product of interest have received a price reduction since a previous shopping trip undertaken by the customer.

14. A system for notifying a customer regarding a product price reduction comprising:
a transaction database adapted to aggregate retail transaction information;
a user account database adapted to aggregate data related to a retail consumer;
a reduced-price product database adapted to aggregate data related to products having recently-reduced prices;
a product identification module adapted to identify products from the reduced-price product database that may be of interest to the customer by analyzing data from the user account database; and
an application server adapted to transmit instructions to an application installed on a mobile computing device, whereby said instructions selectively cause the smartphone to notify the customer regarding recently-reduced prices of products that may be of interest to the customer.

15. The system of claim 14, wherein the reduced-price product database is adapted to aggregate data related to products having received a price reduction in a preceding two week period.

16. The system of claim 14, wherein the reduced-price product database is adapted to aggregate data related to products having received a price reduction since a previous shopping trip undertaken by the customer.

17. A computer-implemented method of notifying a customer of a product price reduction, comprising:
transmitting, from a mobile computing device, a unique identification number corresponding to a retail customer's user account;
displaying, at the mobile computing device, a receipt for a retail transaction between a retailer and the retail customer;
receiving, at the mobile computing device, data related to at least one product of interest to the customer; and
displaying, at the mobile computing device, a notification that the retailer has lowered a retail price of the at least one product of interest;
